(19) United States
(12) Patent Application Publication
(10) Pub. No.: US 2019/0026822 A1
(43) Pub. Date: Jan. 24, 2019

(54) SYSTEM AND METHOD FOR ASSURING PAYMENTS AND RECEIVABLES

(71) Applicants: Inderpal Singh ARORA, Asansol, West Bengal (IN); Bharat THACKER, Asansol, West Bengal (IN); Nitesh SHARMA, Asansol, West Bengal (IN)

(72) Inventors: Inderpal Singh ARORA, Asansol, West Bengal (IN); Bharat THACKER, Asansol, West Bengal (IN); Nitesh SHARMA, Asansol, West Bengal (IN)

(21) Appl. No.: 15/758,362

(22) PCT Filed: Dec. 28, 2017
(86) PCT No.: PCT/IB2017/095000

§ 371 Date: Mar. 8, 2018

(30) Foreign Application Priority Data
Dec. 28, 2016 (IN) 201631044688

(51) Int. Cl. G06Q 40/02; G06Q 40/00; G06Q 20/10

(52) U.S. Cl. CPC G06Q 40/02; G06Q 20/108; G06Q 40/12

(57) ABSTRACT

System of the present disclosure enables execution of assured financial transactions, and comprises a user registration module configured to retrieve actual available balance of users' bank account; an assured receivables module configured to receive one or more future assured receivables for said bank account, each of said one or more future assured receivables indicating an assured irrevocable amount that would be credited to the bank account at a defined future receivables date; an assured payables module configured to receive, from said user, one or more assured future payables to be processed, each of said one or more future assured payables indicating an assured irrevocable amount that would be debited at a defined future payables date; and an assured pay balance computation module configured to compute an assured balance based on said actual available balance in the bank account, said one or more assured receivables, and said one or more assured payables.

### FIELD OF THE INVENTION

The present disclosure relates to the field of executing assured financial transactions. More particularly, the present disclosure relates to a system and method that assures that payables are always paid on a given/fixed date (referred to as assured payables), and receivables are always received (referred to as assured receivables) on a given/fixed date, and further enables use of future assured receivables for making assured payments.

### BACKGROUND

The background description includes information that may be useful in understanding the present invention. It is not an admission that any of the information provided herein is prior art or relevant to the presently claimed invention, or that any publication specifically or implicitly referenced is prior art.

In existing financial ecosystem, there is a trust deficit in the market with regards to payments and all business entities are well aware of it and still nothing has been done to this end. Due to shortage or more requirement of funds, the preferred choice of payment in mostly credit where the receiver uses goods or services today and makes payment for the same at a later date.

In these transactions, the supplier is dependent on goodwill of the receiver and is never sure about the payment amount and the date for payment, which creates an area of concern and limits the scope of business. Many a times, due to no conformity of payment, disputes arise between the supplier and the receiver, which lead to undue stress and at times litigation between the two parties. Also, often times, receivers take advantage of the system and flatly refuse to pay, which results in bad debts and they are always a part of balance sheet of business entities, big or small. When payments are not received in full and or in time, it becomes difficult for a business to keep their commitments to their suppliers which adversely affects their goodwill and credit ratings, thereby making funds planning difficult. As payments can be made to creditors only when payments are received from debtors, non-payment of dues increases both the requirement as well as the cost of funds.

Increase in funds cost also increases the cost of product or services, thereby reducing competitive edge of companies that have limited availability of own capital. Presently some entities use post-dated cheques to assure the receiver that their payment will be cleared but there is no guarantee that the cheque will be honoured for sure and there are millions of cases of bounced cheques still pending in the courts all across the globe, which also increases the burden on courts, which are already overloaded with a lot of cases of different kinds.

Letter of Credit (LC) is also a mode that is sometimes used as assured payment by businessmen but here again, though the payment is assured for the receiver, the payee has to complete a lot of bank formalities and it takes a huge amount of time and effort, and hence this mode is used only for high value transactions, whether it be domestic or import/export business. Furthermore, the payee has to deposit the full amount of payment as bank guarantee or as per their approved LC limits.

There is therefore a need for systems and methods that enables post-dated payments to be made, and at the same time assures that the entire payment amount is transferred/received in full and on the exact date of payment selected in a very simple manner without much bank formalities.

### SUMMARY

The present disclosure relates to the field of executing assured financial transactions. More particularly, the present disclosure relates to a system and method that assures that payables are always paid on a given/fixed date (referred to as assured payables), and receivables are always received (referred to as assured receivables) on a given/fixed date, and further enables use of future assured receivables for making assured payments.

In an aspect, the present disclosure relates to a system comprising a non-transitory storage device having embodied therein one or more routines operable to enable assured financial transactions; and one or more processors coupled to the non-transitory storage device and operable to execute the one or more routines, wherein the one or more routines include: a user registration module, which when executed by the one or more processors, registers a user by receiving information pertaining to a bank account and retrieving actual available balance of said bank account; an assured receivables module, which when executed by the one or more processors, receives, from a second set of users, one or more future assured receivables for said bank account, each of said one or more future assured receivables indicating an assured irrevocable amount that would be credited to the bank account at a defined future receivables date; an assured payables module, which when executed by the one or more processors, receives, from said user, one or more assured future payables to be processed from said bank account to a third set of users, each of said one or more future assured payables indicating an assured irrevocable amount that would be debited from said bank account at a defined future payables date; and an assured pay balance computation module, which when executed by the one or more processors, computes, in real-time, an assured balance for said bank account based on said actual available balance in the bank account, said one or more assured receivables, and said one or more assured payables, wherein said user is allowed to pre-claim at least a part of the one or more assured receivables before said part of said one or more assured receivables is actually credited to the bank account.

In an aspect, at least a second part of the one or more future assured receivables can be booked for meeting at least a part of said one or more assured future payables after said second part of the one or more future assured receivables is credited to the bank account.

In another aspect, interest is charged to the user based on the date on which the at least a part of the one or more assured receivables is pre-claimed, and the date on which the at least a part of the one or more assured receivables is actually credited.

In an aspect, the proposed system does not allow said user to book an accounts payable that is greater than the assured balance, wherein the assured balance is computed as a sum of said actual available balance in the bank account and said one or more assured receivables minus said one or more assured payables.

In an aspect, at least one of the one or more future assured payables can be determined automatically from a transaction note presented to the user, wherein the transaction note can be any or a combination of an invoice, a quotation, a purchase order, and a document that comprises a payable amount and payment date.

In an aspect, the proposed system can include a prediction engine that can be configured to, based on historical changes in any or a combination of said actual available balance in the bank account, said one or more assured receivables, and said one or more assured payables, predict funds flow from said bank account. Such prediction can help user to understand how they should plan their funds flow, what their receivable trends are, what their payable trends are so that they can process/plan their future business transactions accordingly. In an aspect, the proposed system can further include a suggestion engine that can, based on prediction(s) performed by the prediction engine, suggest how the user should organize his/her/its funds flow, what seasonal variations does the user transactions have, during what time periods does the user have more receivables than payables, and during what time periods does the user have more payables than receivables. The suggestion engine can also indicate objectively what user's actions should be while committing to payables so that the future receivables can be pre-claimed and used in a manner so as to reduce liabilities and interest.

In an aspect, the proposed system can further include a rating engine that can be configured to enable any or a combination of the second set of users, said user, and said third set of users to be rated by each other and/or by said system to enable reliability determination of said rated user.

In an aspect, method of the present disclosure can include the steps of registering, at a server, a user by receiving information pertaining to a bank account and retrieving actual available balance of said bank account; receiving, at said server, from a second set of users, one or more future assured receivables for said bank account, each of said one or more future assured receivables indicating an assured irrevocable amount that would be credited to the bank account at a defined future receivables date; receiving, at said server, from said user, one or more assured future payables to be processed from said bank account to a third set of users, each of said one or more future assured payables indicating an assured irrevocable amount that would be debited from said bank account at a defined future payables date; and computing, at said server, in real-time, an assured balance for said bank account based on said actual available balance in the bank account, said one or more assured receivables, and said one or more assured payables, wherein said user is allowed to pre-claim at least a part of the one or more assured receivables before said part of said one or more assured receivables is actually credited to the bank account.

In an aspect, at least a second part of the one or more future assured receivables is booked for meeting at least a part of said one or more assured future payables after said second part of the one or more future assured receivables is credited to the bank account.

In an aspect, an interest is charged to said user based on the date on which said at least a part of the one or more assured receivables is pre-claimed, and the date on which said at least a part of the one or more assured receivables is actually credited.

In another aspect, the user may not be allowed to book an accounts payable that is greater than the assured balance, said assured balance being computed as a sum of said actual available balance in the bank account and said one or more assured receivables minus said one or more assured payables.

In another aspect, at least one of the one or more future assured payables can be determined automatically from a transaction note presented to the user, wherein said transaction note is any or a combination of an invoice, a quotation, and a purchase order, and a document that comprises a payable amount and payment date.

### BRIEF DESCRIPTION OF THE DRAWINGS

FIG. 1 illustrates an exemplary system architecture of the proposed invention in accordance with an aspect of the present disclosure.

FIGS. 2A to 2E illustrate exemplary representations of how AssuredPay books of users A-E would be represented in accordance with an exemplary embodiment of the present disclosure. The present disclosure relates to the field of executing assured financial transactions. More particularly, the present disclosure relates to a system and method that assures that payables are always paid on a given/fixed date (referred to as assured payables), and receivables are always received (referred to as assured receivables) on a given/fixed date, and further enables use of future assured receivables for making assured payments.

FIG. 3 illustrates another exemplary representation showing working of the proposed receivable and payable based assurity system in accordance with an embodiment of the present invention.

FIG. 4 illustrates an exemplary flow diagram in accordance with an aspect of the present invention.

FIG. 5A illustrates an exemplary flow diagram showing how a pre-claimable transaction can be executed in accordance with an aspect of the present invention.

FIG. 5B illustrates an exemplary flow diagram showing how a payment can be received through the proposed system in accordance with an aspect of the present invention.

FIG. 5C illustrates an exemplary flow diagram showing how a payment can be made through the proposed system in accordance with an aspect of the present invention.

### DETAILED DESCRIPTION

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms are used herein. To the extent a term used in a claim is not defined below, it should be given the broadest definition persons in the pertinent art have given that term as reflected in printed publications and issued patents at the time of filing.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

The terms “configured to” and “programmed to” in the context of a processor refer to being programmed by a set of software instructions to perform a function or set of functions.

Unless the context dictates the contrary, ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

The following discussion provides many example embodiments. Although each embodiment represents a single combination of components, this disclosure contemplates combinations of the disclosed components. Thus, for example, if one embodiment comprises components A, B, and C, and a second embodiment comprises components B and D, then the other remaining combinations of A, B, C, or D are included in this disclosure, even if not explicitly disclosed. As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, numerical parameters expressing quantities are used. It is to be understood that such numerical parameters may not be exact, and are instead to be understood as being modified in some instances by the term “about.” Accordingly, in some embodiments, a numerical parameter is an approximation that can vary depending upon the desired properties sought to be obtained by a particular embodiment.

The present disclosure relates to the field of executing assured financial transactions. More particularly, the present disclosure relates to a system and method that assures that payables are always paid on a given/fixed date (referred to as assured payables), and receivables are always received (referred to as assured receivables) on a given/fixed date, and further enables use of future assured receivables for making assured payments.

In an aspect, the present disclosure relates to a system comprising a non-transitory storage device having embodied therein one or more routines operable to enable assured financial transactions; and one or more processors coupled to the non-transitory storage device and operable to execute the one or more routines, wherein the one or more routines include: a user registration module, which when executed by the one or more processors, registers a user by receiving information pertaining to a bank account and retrieving actual available balance of said bank account; an assured receivables module, which when executed by the one or more processors, receives, from a second set of users, one or more future assured receivables for said bank account, each of said one or more future assured receivables indicating an assured irrevocable amount that would be credited to the bank account at a defined future receivables date; an assured payables module, which when executed by the one or more processors, receives, from said user, one or more assured future payables to be processed from said bank account to a third set of users, each of said one or more future assured payables indicating an assured irrevocable amount that would be debited from said bank account at a defined future payables date; and an assuredpay balance computation module, which when executed by the one or more processors, computes, in real-time, an assured balance for said bank account based on said actual available balance in the bank account, said one or more assured receivables, and said one or more assured payables, wherein said user is allowed to pre-claim at least a part of the one or more assured receivables before said part of said one or more assured receivables is actually credited to the bank account.

In an aspect, at least a second part of the one or more future assured receivables can be booked for meeting at least a part of said one or more assured future payables after said second part of the one or more future assured receivables is credited to the bank account.

In another aspect, interest is charged to the user based on the date on which the at least a part of the one or more assured receivables is pre-claimed, and the date on which the at least a part of the one or more assured receivables is actually credited.

In an aspect, the proposed system does not allow said user to book an accounts payable that is greater than the assured balance, wherein the assured balance is computed as a sum of said actual available balance in the bank account and said one or more assured receivables minus said one or more assured payables.

In an aspect, at least one of the one or more future assured payables can be determined automatically from a transaction note presented to the user, wherein the transaction note can be any or a combination of an invoice, a quotation, a purchase order, and a document that comprises a payable amount and payment date.

In an aspect, the proposed system can include a prediction engine that can be configured to, based on historical changes in any or a combination of said actual available balance in the bank account, said one or more assured receivables, and said one or more assured payables, predict funds flow from said bank account. Such prediction can help user to understand how they should plan their funds flow, what their receivable trends are, what their payable trends are so that they can process/plan their future business transactions accordingly. In an aspect, the proposed system can further include a suggestion engine that can, based on prediction(s) performed by the prediction engine, suggest how the user should organize his/her/its funds flow, what seasonal variations does the user transactions have, during what time periods does the user have more receivables than payables, and during what time periods does the user have more payables than receivables. The suggestion engine can also indicate objectively what user's actions should be while committing to payables so that the future receivables can be pre-claimed and used in a manner so as to reduce liabilities and interest.

In an aspect, the proposed system can further include a rating engine that can be configured to enable any or a combination of the second set of users, said user, and said third set of users to be rated by each other and/or by said system to enable reliability determination of said rated user.

In an aspect, method of the present disclosure can include the steps of registering, at a server, a user by receiving information pertaining to a bank account and retrieving actual available balance of said bank account; receiving, at said server, from a second set of users, one or more future assured receivables for said bank account, each of said one or more future assured receivables indicating an assured irrevocable amount that would be credited to the bank account at a defined future receivables date; receiving, at said server, from said user, one or more assured future payables to be processed from said bank account to a third set of users, each of said one or more future assured payables indicating an assured irrevocable amount that would be debited from said bank account at a defined future payables date; and computing, at said server, in real-time, an assured balance for said bank account based on said actual available balance in the bank account, said one or more assured receivables, and said one or more assured payables, wherein said user is allowed to pre-claim at least a part of the one or more assured receivables before said part of said one or more assured receivables is actually credited to the bank account.

In an aspect, at least a second part of the one or more future assured receivables is booked for meeting at least a part of said one or more assured future payables after said second part of the one or more future assured receivables is credited to the bank account.

In an aspect, an interest is charged to said user based on the date on which said at least a part of the one or more assured receivables is pre-claimed, and the date on which said at least a part of the one or more assured receivables is actually credited.

In another aspect, the user may not be allowed to book an accounts payable that is greater than the assured balance, said assured balance being computed as a sum of said actual available balance in the bank account and said one or more assured receivables minus said one or more assured payables.

In another aspect, at least one of the one or more future assured payables can be determined automatically from a transaction note presented to the user, wherein said transaction note is any or a combination of an invoice, a quotation, and a purchase order.

The present disclosure relates to the field of financial transactions. More particularly, the present disclosure relates to a system and method that assures that payables are always paid (referred to as assured payables) on said date, and receivables are always received (referred to as assured receivables) on said date, and further enables use of future assured receivables for making assured payments.

In the aspect, the present disclosure relates to a system (also referred to as a platform) and method by which a user (term to include reference to a businessman or a professional or any other user that can implement aspects of the present disclosure) can use his/her funds and receivables to make payments on a post dated basis such that the payments are honored for sure on the given date, thereby controlling fairness of business. More particularly, the present system assures the receiver that the payment is received on the receipt date for sure, and he/she can use this receivable to make payment commitments to his creditors on the day of his/her sale. The present disclosure therefore links all banks, and accounts to ensure its basic principal of assured payments.

In an aspect, the present disclosure relates to a system that enables a mechanism by means of which payables are always honoured without fail since the system allows making payments only through available balance, which is irrevocable and is blocked for this payment transaction. System of the present disclosure is basically an assurance platform, where each member/user of the system makes a financial commitment to pay his payables (assured payables) by a defined date, and it also receives due receivables at due time (assured receivables), wherein such a commitment is always honored as the due amounts are locked in by respective parties in advance. Such commitment also enables user to use a future assured receivable amount before actually receiving the same.

In an aspect, because of the proposed system (also referred to as AssuredPay™), supplier does not need to know or even meet the purchaser as his payments will be assured. As the payments (assured receivables and assured payables) are assured, undesired bank interest can also be saved. Since the payment is assured (by the buyer) to the seller (as the due amount from the buyer would be locked for payment in advance), the seller can easily get a credit from a supplier (through the proposed system) who otherwise will sell you goods only on cash payment. Therefore, the seller can save interest for the period from the invoice date to the payment date, which can add significantly to the profits. Because of the proposed architecture, working capital is also reduced as receivables can be used for payments. The proposed system also removes the of payment collection part from the business cycle.

A normal business credit transaction ends after follow-up and full collection of payment. However, through the proposed system, the transaction will complete on the date of sale itself, thereby removing an expensive, time consuming, and uncertain process. The proposed system also removes the need for any cash transactions, thereby bringing in the necessary transparency. In an aspect, the proposed system can also implement a rating system that can be maintained for both the buyers and sellers based on customers feedbacks and volumes of business/system generated, which can help new customers in evaluating their buyers/suppliers.

In an exemplary implementation of the proposed system, business entity (could be buyer or seller) can be configured to initially open a joint bank account wherein the business entity will be the initiator and AssuredPay will be the validator with the proposed platform/system (after initial registration with the proposed system), and then make funds available in this bank account for transactions through this platform. It should be appreciated that although aspects of the present disclosure have been explained with respect to one entity having one account associated with the proposed system, it would be appreciated that one entity can always link multiple bank accounts with the proposed system, wherein processing of each bank account may be different and independent of the other. From the linked bank account, the entity can make a payment by selecting a future date in a manner such that the funds will remain in the bank account but get blocked (also referred to as locked) till the date of payment, and on the payment due date, funds will automatically transfer from this account to the receiver's account, and therefore payments made from the business entity are assured payables, and payments received by the receiver are assured receivables. As the future receivables are assured, in an aspect, payee/receiver can also use its future receivables for payment commitments on a future or current date (term also interchangeably referred to as Pre-claimed AssuredPay Balance).

### Definitions in Context of the Present Invention

AssuredPay Payables refers to any Payments to be paid through AssuredPay. This amount gets blocked on the date the payment is booked, and gets transferred to Receiver's Account on the date of Payment.
AssuredPay Receivables refers to any Payments to be Received through AssurdPay. AssuredPay Receivables can be used to make AssuredPay Payments, and can also be Pre-Claimed to make AssuredPay Payments.
AssuredPay Payables Account Balance refers to the sum of all Payables routed through the proposed system on any given date.
AssuredPay Receivables Account Balance refers to the sum of all receivables routed through the proposed system on any given date.
Actual Bank Account Opening Balance refers to actual cash balance on beginning of a day on a given date in the joint account (irrespective of the blocked amount and also the receivables).
Actual Bank Account Closing Balance refers to actual cash balance at the end of the day i.e. “Actual Bank Account Opening Balance”+all AssuredPay Receivables received on that day −all AssuredPay Payables payments made on that day (irrespective of blocked amount and also receivables), which in turn can help in calculating interest payable or receivable from the bank.
Opening AssuredPay Balance refers to the Closing AssuredPay Balance of the Previous Day.
Closing AssuredPay Balance refers to AssuredPay balance at the end of the day i.e. “Opening AssuredPay Balance”—all AssuredPay Payables booked on that day+all AssuredPay Receivables Received on that day.
Receivables booked for Payment refers to the AssuredPay Receivables used to book AssuredPay payments on that day from the AssuredPay Receivable Account Balance.
Receivable booked for Payment Account Balance refers to the sum of total AssuredPay Receivables being used for booking AssuredPay Payables i.e “Previous day Receivable booked for Payment Account Balance+Receivable booked for Payment−AssuredPay Receivables received on that day.
Available AssuredPay Balance refers to the total amount available for booking AssuredPay Payables on that day i.e. Closing AssuredPay Balance+AssuredPay Receivable Account Balance on that day.
Pre-Claimable AssuredPay Balance refers to When AssuredPay Receivables is used to book AssuredPay Payables and if the Payment date is before the receivable date then the said amount will be termed as Pre-Claimable Amount and an interest will be charged.

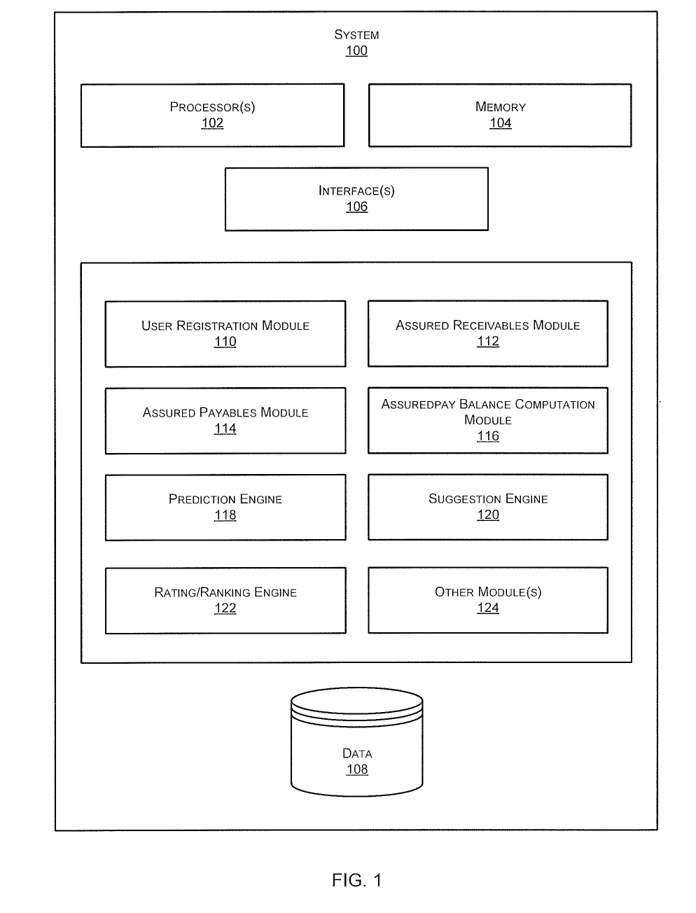

FIG. 1 illustrates an exemplary system architecture 100 of the proposed invention in accordance with an aspect of the present disclosure. In an exemplary aspect, the proposed system 100 can include one or more processor(s) 102. Each of the one or more processor(s) 102 can comprise plurality of core processors. The one or more processor(s) 102 can be implemented as one or more microprocessors, microcomputers, microcontrollers, digital signal processors, central processing units, logic circuitries, and/or any devices that manipulate data based on operational instructions. Among other capabilities, the one or more processor(s) 102 are configured to fetch and execute computer-readable instructions stored in a memory 104 of the system 100. The memory 104 can store one or more computer-readable instructions or routines, which may be fetched and executed to create or share the data units over a network service. The memory 104 can include any non-transitory storage device including, for example, volatile memory such as RAM, or non-volatile memory such as EPROM, flash memory, and the like.

The system 100 can also include an interface(s) 106. The interface(s) 106 may include a variety of interfaces, for example, interfaces for data input and output devices, referred to as I/O devices, storage devices, and the like. The interface(s) 106 may facilitate communication of the system 100 with various devices coupled to the system 100. The interface(s) 106 may also provide a communication pathway for one or more components of the system 100.

In an aspect, system of the present disclosure can be implemented as a combination of hardware and programming (for example, programmable instructions) to implement one or more configured/desired functionalities. In examples described herein, such combinations of hardware and programming may be implemented in several different ways. For example, programming for the proposed system may be processor executable instructions stored on a non-transitory machine-readable storage medium and the hardware for the engine(s) may include a processing resource (for example, one or more processors), to execute such instructions. In the present examples, the machine-readable storage medium may store instructions that, when executed by the processing resource, implement the engine(s). In such examples, the system 100 can include the machine-readable storage medium storing the instructions and the processing resource to execute the instructions, or the machine-readable storage medium may be separate but accessible to system 100 and the processing resource. In other examples, the proposed system may be implemented by electronic circuitry. The data 108 can include data that is either stored or generated as a result of functionalities implemented by any of the components of the proposed system. The proposed system can be configured to interact with interface(s) 106 to facilitate communication of the system 100 with various devices coupled to the system 100.

In an example, the proposed system can include a user registration module 110, which when executed by the one or more processors, registers a user by receiving information pertaining to a bank account and retrieving actual available balance of said bank account. In an aspect, the proposed system can further include an assured receivables module 112, which when executed by the one or more processors, receives, from a second set of users, one or more future assured receivables for said bank account, each of said one or more future assured receivables indicating an assured irrevocable amount that would be credited to the bank account at a defined future receivables date, and therefore amounts pertaining to said one or more future assured receivables are blocked for said respective second set of users. For instance if users and A and B, using the proposed system commit to pay USD 100 and 50 respectively to user C, user C can see the future assured receivables of USD 100 and 50 in his account, and also, as mentioned below, pre-claim the amount of USD 150 less interest using said future assured receivables.

In another aspect, system of the present disclosure can further include an assured payables module 114, which when executed by the one or more processors, receives, from said user, one or more assured future payables to be processed from said bank account to a third set of users, each of said one or more future assured payables indicating an assured irrevocable amount that would be debited from said bank account at a defined future payables date. For instance, in the above example, user C can enable an assured future payable of USD 100 such that this amount is blocked from his bank account and cannot be used for any further transaction. In another instance, if the actual available balance in the bank account of the user C is USD 200 and his assured receivables are USD 50 and USD 100, if he makes a assured future payable of USD 300, the proposed system would not allow him to make any other assured future payable of more than USD 50.

In another aspect, the proposed system can include an AssuredPay balance computation module 116, which when executed by the one or more processors, computes, in real-time, an assured balance for said bank account based on said actual available balance in the bank account, said one or more assured receivables, and said one or more assured payables, wherein said user is allowed to pre-claim at least a part of the one or more assured receivables before said part of said one or more assured receivables is actually credited to the bank account. For instance, if available balance in the bank account of the user C is USD 200 and his assured receivables are USD 50 and USD 100, the user C can pre-claim any amount up to USD 150 less interest.

In an aspect, at least a second part of the one or more future assured receivables can be booked for meeting at least a part of said one or more assured future payables after said second part of the one or more future assured receivables is credited to the bank account. For instance, if available balance in the bank account of the user C is USD 200 and his assured receivables are USD 50 and USD 100, the user C can make an assured future payable of upto USD 350.

In an exemplary aspect, interest may be configured to be charged to the user based on the date on which the at least a part of the one or more assured receivables is pre-claimed, and the date on which the at least a part of the one or more assured receivables is actually credited. For instance, if available balance in the bank account of the user C is USD 200 and his assured receivable is USD 50 after 10 days, if the user pre-claims the future assured receivable today itself (i.e. 10 days before), system of the present disclosure can be configured to charge an interest of 10 days to said user.

In an aspect, the proposed system does not allow said user to book an accounts payable that is greater than the assured balance, wherein the assured balance is computed as a sum of said actual available balance in the bank account and said one or more assured receivables minus said one or more assured payables.

In an aspect, at least one of the one or more future assured payables can be determined automatically from a transaction note presented to the user, wherein the transaction note can be any or a combination of an invoice, a quotation, a purchase order, and a document that comprises a payable amount and payment date.

In an aspect, the proposed system can include a prediction engine 118 that can be configured to, based on historical changes in any or a combination of said actual available balance in the bank account, said one or more assured receivables, and said one or more assured payables, predict funds flow from said bank account. Such prediction can help user to understand how they should plan their funds flow, what their receivable trends are, what their payable trends are so that they can process/plan their future business transactions accordingly. In an aspect, the proposed system can further include a suggestion engine 120 that can, based on prediction(s) performed by the prediction engine, suggest how the user should organize his/her/its funds flow, what seasonal variations does the user transactions have, during what time periods does the user have more receivables than payables, and during what time periods does the user have more payables than receivables. The suggestion engine can also indicative objectively what user's actions should be while committing to payables so that the future receivables can be pre-claimed and used in a manner so as to reduce liabilities and interest.

In an aspect, the proposed system can further include a rating/ranking engine 122 that can be configured to enable any or a combination of the second set of users, said user, and said third set of users to be rated by each other and/or by said system to enable reliability determination of said rated user. In an aspect, such rating/ranking can be performed based on quality of goods/services being rendered by the users, wherein, for instance, in case user C receives assured receivables of USD 50 and 100 from users A and B respectively, users A and B can rank user C on the quality of goods/services supplied by user C to both the users. As would be appreciated, any other module such as 124 can also be configured as desired, and even the proposed modules can be divided into further sub-modules, making any such construction/configuration well within the scope of the present invention.

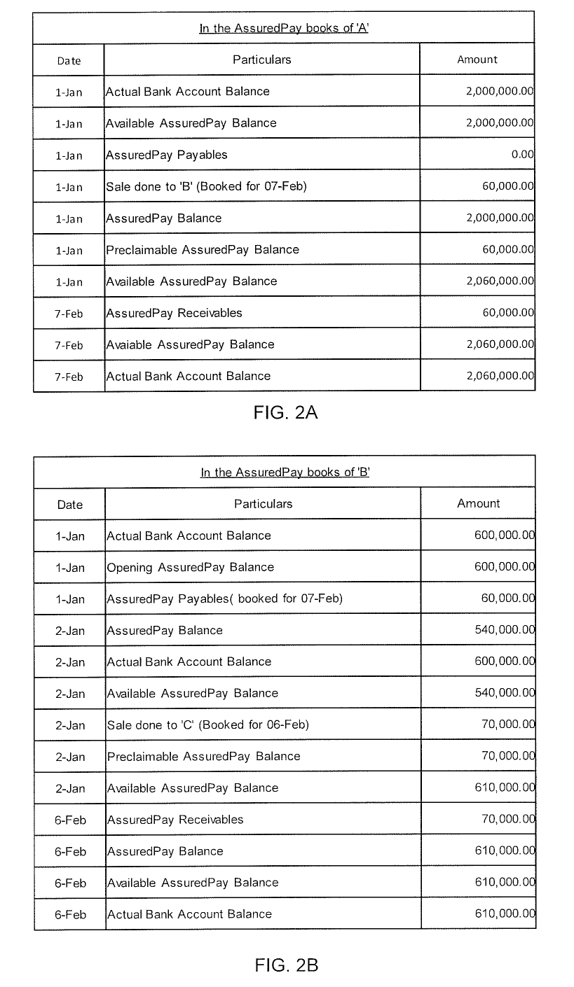

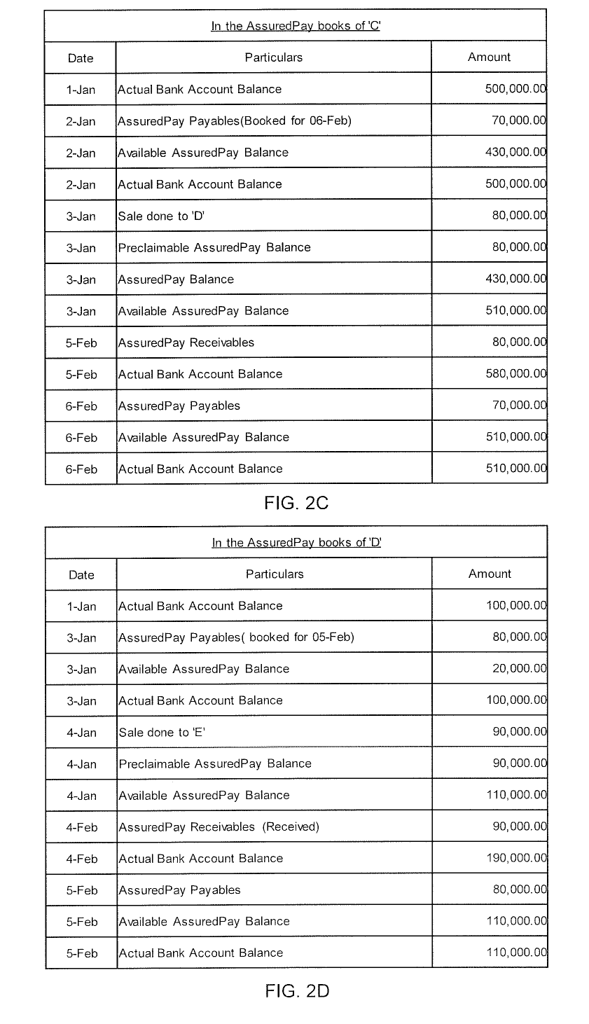

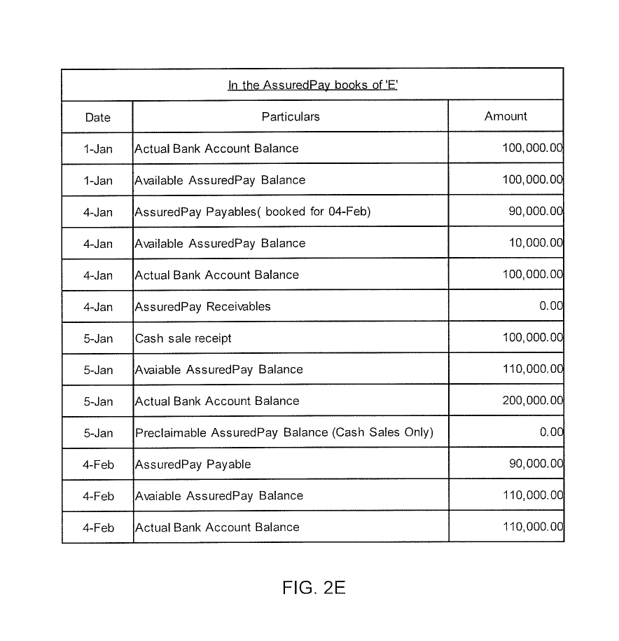

FIGS. 2A to 2E illustrate exemplary representations of how AssuredPay books of users A-E would be represented in accordance with an exemplary embodiment of the present disclosure. As shown with respect to FIG. 2A showing books of user A, a sale of USD 60000 for product P is done by user A to user B, where the Actual Bank Account Balance and Available AssuredPay Balance of user A is USD 2,000,000, and Assured Payables (B) is USD 0. With the sale on 1'st January, the available AssuredPay Balance becomes USD 2,060,000, out of which USD 60000 can be pre-claimed or even used for paying Assured Payables.

As user B uses the proposed system, he/she books an assured payment of USD 60000 (as mentioned in AssuredPay Payables) for user A's sale, to be done on 7'th February, making the Available AssuredPay Balance for user B to be USD 540,000 as USD 60000 is blocked from his account. In turn, user B sells the same product P down the chain on 2'nd January to user C for USD 70000, making his/her AssuredPay Receivables to be USD 70000 (refer FIG. 2B), making the final AssurePay Balance to be USD 610000 (by blocking of USD 70000 from user C's bank account). User C subsequently buys the sold item from user B, and books an assured payment for user B's sale to be done on 6'th February (as seen in FIG. 2C). This same process can be carried on till user E (FIG. 2E), who has assured, through the proposed system, that the payment would be made on 4'th February As all these payments are assured, amounts of these payments are blocked through the proposed system (configured between the bank and the user, for instance) sooner the payable is booked so as to ensure that commitments to receivers of payments are honored. Based on amounts of Assured Payables and Assured Receivables, values of other parameters such as Pre-claimable AssuredPay Balance, AssuredPay Receivables (Received), AssuredPay Payables (Paid), Available AssuredPay Balance, and Actual Bank AccountBalance are computed accordingly based on AssuredPay Payables, AssuredPay Receivables, and Actual Opening AssuredPay Balance.

Aspects of the present disclosure therefore relate to a payment tool/platform/system that allows post-dated payments that are assured by blocking the amount in bank account of payee on the date the payment is assured till the date the payment is made. The system further allows future receivables through “AssuredPay” to be used to ensure payments after the date on which the amount is to be received after deducting “AssuredPay” payables. The system further allows future receivables after deducting all future payables to be used to ensure payments on a current date with or without deduction of interest. The system further connects bank accounts and controls transfer of funds based on Actual Bank Accountbalance, Available AssuredPay balance, and Pre Claimable AssuredPay balance.

In an aspect, based on feedback of business entities, a credit rating of a particular business entity can be maintained, which rating can be helpful to business entities that don't have proper knowledge of supplying company/entity. In an aspect, platform of the present disclosure can be configured in a computing architecture that can be downloaded by business entities and then configured and linked with their respective bank accounts for undertaking transactions through the system.

The proposed system further allows credit to become available for the amount of receivables that are over and above the sum of all payables on any given date. The system also allows proper financial planning to be made based on fixed date of payments to be made and received.

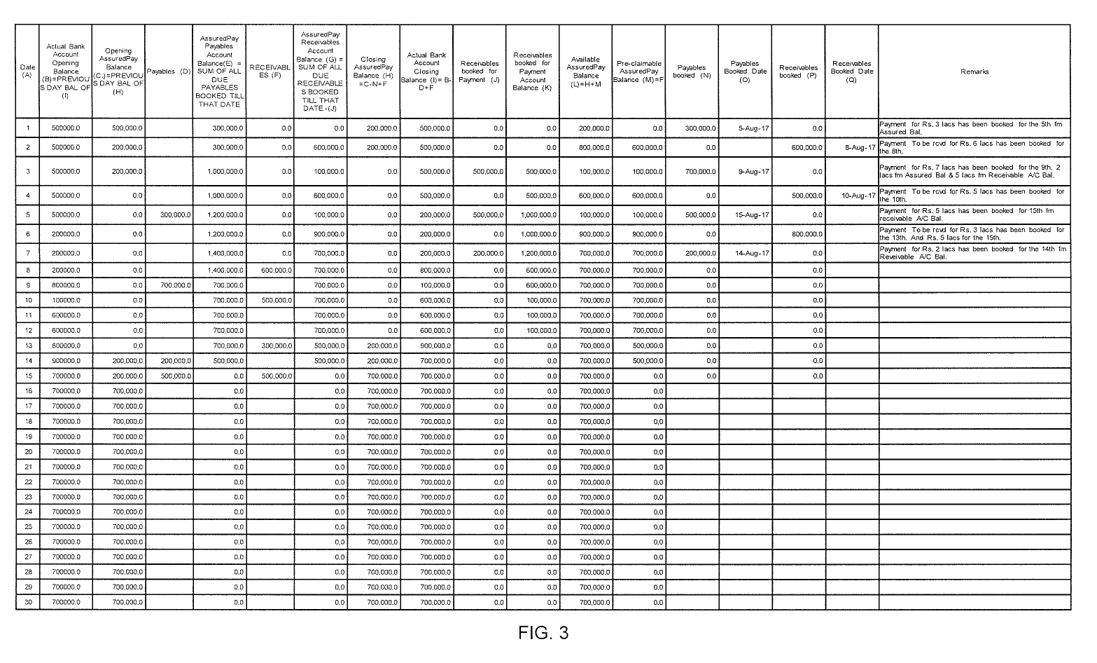

FIG. 3 illustrates another exemplary representation showing working of the proposed receivable and payable based assurity system in accordance with an embodiment of the present invention. As can be seen, column B shows the actual bank opening balance (also referred to as actual bank balance), which is the previous day end of date balance of column I. Column C, on the other hand, shows the opening AssuredPay balance which is computed in column H as the Opening AssuredPay Balance−Payables Booked on that Day (Column N)+Receivables (Column F). Column D shows the actual Payables, and Column E shows AssuredPay Payables Account Balance, which is the sum of all due Payables booked till that date. Column G pertains to the AssuredPay Receivables Account Balance, which is the sum of all due Receivables booked till that date. Column J shows the Receivables booked for payment, whereas Column K pertains to Receivables booked for Payment Account Balance. Column L pertains to available AssuredPay Balance which is the sum of Closing AssuredPay Balance and Pre-claimable AssuredPay Balance.

As can be seen from the Remarks section, on Date 1, Payment for INR 3 Lakhs is booked for the Date 5 from Assured Balance, wherein, as can be seen from Column D, the Assured Payable amount has been automatically paid on Date 5. Similarly, on Date 2, payment of INR 6 Lakhs is to be received for Date 8, entry for which can be seen in column G on Date 2 whereas the impact of this Assured Receivable can be seen at Column G of AssuredPay Receivables Account Balance, and Column M of Pre-claimable AssuredPay Balance. Remark in Date 3 indicates an Assured Payable amount of INR 7 Lakhs that needs to be paid on Date 9, based on which 2 Lakhs are adjusted from Opening AssuredPay Balance (Column C) and the balance 5 Lakhs is taken from receivable account balance and the same entry is reflected in Receivables booked for Payment (Column J). Similarly further computation of future transactions are also reflected in FIG. 3.

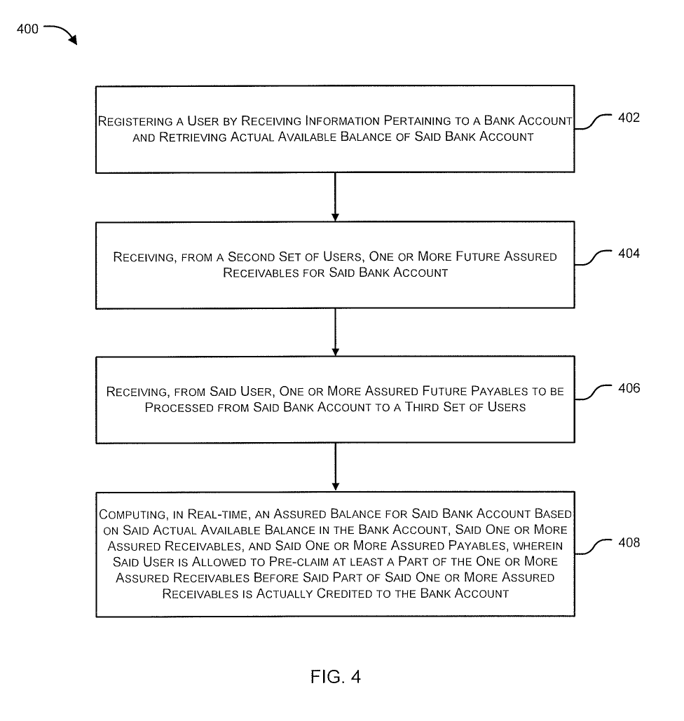

FIG. 4 illustrates an exemplary flow diagram 400 in accordance with an aspect of the present invention. In an aspect, method of the present disclosure can include the steps of, at step 402, registering, at a server, a user by receiving information pertaining to a bank account and retrieving actual available balance of said bank account; at step 404, receiving, at said server, from a second set of users, one or more future assured receivables for said bank account, each of said one or more future assured receivables indicating an assured irrevocable amount that would be credited to the bank account at a defined future receivables date; at step 406, receiving, at said server, from said user, one or more assured future payables to be processed from said bank account to a third set of users, each of said one or more future assured payables indicating an assured irrevocable amount that would be debited from said bank account at a defined future payables date; and at step 408, computing, at said server, in real-time, an assured balance for said bank account based on said actual available balance in the bank account, said one or more assured receivables, and said one or more assured payables, wherein said user is allowed to pre-claim at least a part of the one or more assured receivables before said part of said one or more assured receivables is actually credited to the bank account.

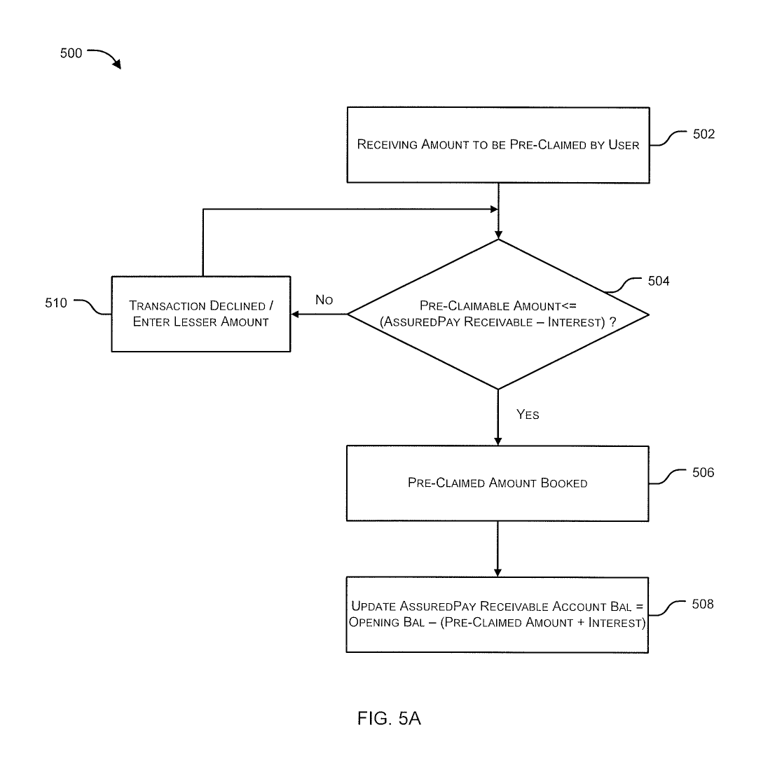

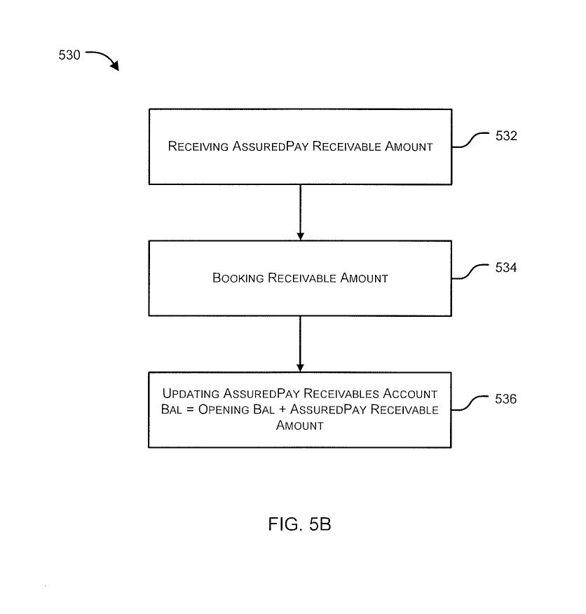

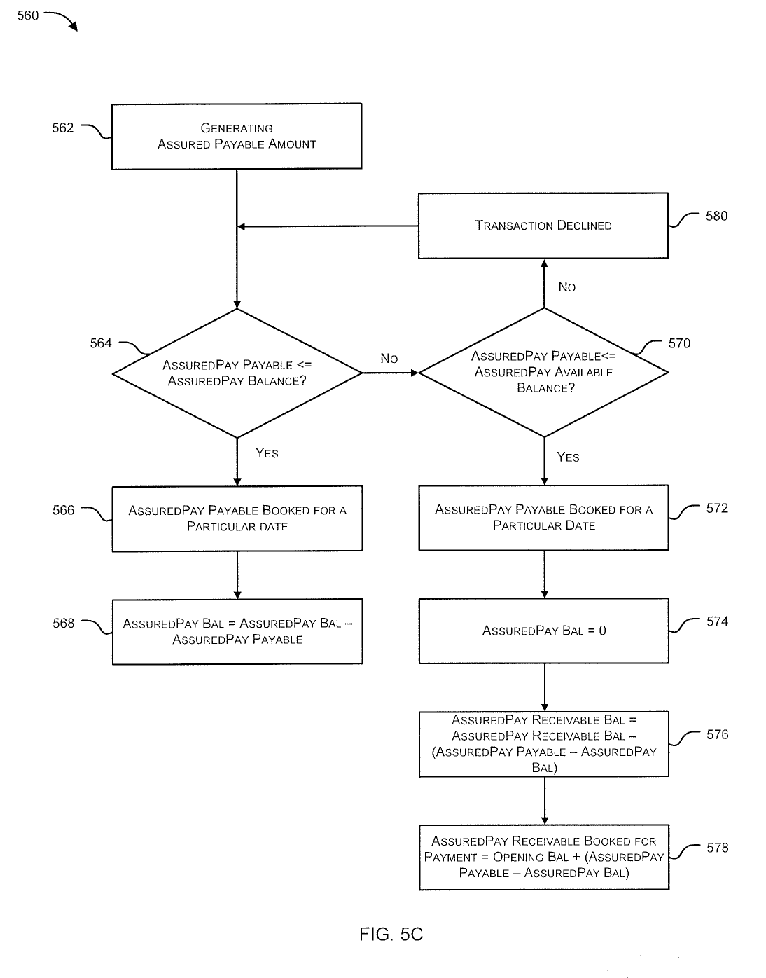

FIG. 5A illustrates an exemplary flow diagram showing how a pre-claimable transaction can be executed in accordance with an aspect of the present invention. In an aspect, of the present disclosure, a bank account holder/user can, using the proposed system, be enabled to pre-claim a future receivable amount, wherein for instance, if the current actual bank balance of the user is USD 10000, and USD 1500 is assured to be received by the user after 10 days, said user can pre-claim the USD 1500 amount as on today and make transactions accordingly. At step 502, the proposed system can receive an amount that the user wishes to pre-claim (referred to as pre-claimable amount), based on which at step 504, the system can be configured to check if the pre-claimable amount is less than or equal to AssuredPay receivable minus (−) Interest. At step 506, if the pre-claimable amount is determined to be less than or equal to AssuredPay receivable minus (−) Interest, the pre-claimed amount is booked, and at step 508, the AssuredPay Receivable Account Balance can be computed as Opening Balance−(Pre-claimed Amount+Interest). On the other hand, if the pre-claimable amount is determined to be more than the AssuredPay receivable minus (−) Interest, at step 510, the initiated transaction is declined or the user can be asked to submit a lesser amount that is intended to be pre-claimed.

FIG. 5B illustrates an exemplary flow diagram showing how a payment can be received through the proposed system in accordance with an aspect of the present invention. At step 532, the AssuredPay Receivable Amount is received by the proposed system, at step 534, the Receivables are booked, post which at step 536, a revised AssuredPay Receivables Account Bal is computed as being equal to (Opening Bal+AssuredPay Receivable Amount).

FIG. 5C illustrates an exemplary flow diagram showing how a payment can be made through the proposed system in accordance with an aspect of the present invention. At step 562, an assured payable amount is generated from the AssuredPay Account of a user, wherein at step 564, it is checked if the Assured Payable Amount is less than or equal to the Assured Balance such that if the Assured Payable Amount is less than or equal to the Assured Balance, at step 566, Assured Payable Amount is booked for a particular date, and at step 568, updated AssuredPay Balance is computed as AssuredPay Balance−Assured Payable Amount. On the other hand, if the Assured Payable Amount is more than the Assured Balance, at step 570, it is checked if Assured Payable Amount is less than or equal to AssuredPay Available with the user such that if the Assured Payable Amount is less than or equal to AssuredPay Available, at step 572, Assured Payable Amount is booked for a particular date and at step 574, the AssuredPay Balance is updated as being 0. At step 576, AssuredPay Receivable Balance is revised/updated as AssuredPay Receivable Balance−(AssuredPay Payable−AssuredPay Balance), and at step 578, the AssuredPay Receivable Booked for Payment is revised/updated as Opening Bal+(AssuredPay Payable−AssuredPay Bal). On the other hand, if the Assured Payable Amount is more than AssuredPay Available, the transaction is declined.

In an aspect, technical effect of the present invention lies in the manner that the proposed system, in real-time, enables computation of how much assure balance would a user have at any given point of time, which none of the existing arts enable manually or through any computer enabled architectures. Such computation in an exact manner is not even possible manually as there is no assurity of payments/commitments that are made. It is only through the present invention that the user is able to accurately understand the actual balance that the user would have, say after 10 days, or 10 weeks, or 10 months, and hence gives him an exact fund flow management. Furthermore, as the proposed system is configured between the user's bank and the user, all features of what the user's bank allows can be performed through the system of the present invention. In addition, the proposed system also uniquely, through the internal configuration of the technical architecture, allows the user to pre-claim a future assured receivable amount, which current system absolutely do not even manually allow or cater to. Users are further allowed, through the data structure proposed in the present invention, to commit to future payments that they would be issuing (future assured payables), making it very clear and transparent for each party to review their exact fund flow situation and make claims before the amounts are actually credited to the users' bank account or even commit to a payment when they don't even, at that moment, have the necessary funds but their future assured receivables would allow them to meet the commitments.

It would be appreciated that the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

We claim:

1. A system comprising:
a non-transitory storage device having embodied therein one or more routines operable to enable assured financial transactions; and
one or more processors coupled to the non-transitory storage device and operable to execute the one or more routines, wherein the one or more routines include:
a user registration module, which when executed by the one or more processors, registers a user by receiving information pertaining to a bank account and retrieving actual available balance of said bank account;
an assured receivables module, which when executed by the one or more processors, receives, from a second set of users, one or more future assured receivables for said bank account, each of said one or more future assured receivables indicating an assured irrevocable amount that would be credited to the bank account at a defined future receivables date;
an assured payables module, which when executed by the one or more processors, receives, from said user, one or more assured future payables to be processed from said bank account to a third set of users, each of said one or more future assured payables indicating an assured irrevocable amount that would be debited from said bank account at a defined future payables date;
an assured pay balance computation module, which when executed by the one or more processors, computes, in real-time, an assured balance for said bank account based on said actual available balance in the bank account, said one or more assured receivables, and said one or more assured payables, wherein said user is allowed to pre-claim at least a part of the one or more assured receivables before said part of said one or more assured receivables is actually credited to the bank account.

2. The system of claim 1, wherein at least a second part of the one or more future assured receivables is booked for meeting at least a part of said one or more assured future payables after said second part of the one or more future assured receivables is credited to the bank account.

3. The system of claim 1, wherein an interest is charged to said user based on the date on which said at least a part of the one or more assured receivables is pre-claimed, and the date on which said at least a part of the one or more assured receivables is actually credited.

4. The system of claim 1, wherein said system does not allow said user to book an accounts payable that is greater than the assured balance, said assured balance being computed as a sum of said actual available balance in the bank account and said one or more assured receivables minus said one or more assured payables.

5. The system of claim 1, wherein at least one of the one or more future assured payables is determined automatically from a transaction note presented to the user.

6. The system of claim 5, wherein said transaction note is any or a combination of an invoice, a quotation, a purchase order, and a document that comprises a payable amount and payment date.

7. The system of claim 1, wherein said system comprises a prediction engine configured to, based on historical changes in any or a combination of said actual available balance in the bank account, said one or more assured receivables, and said one or more assured payables, predict funds flow from said bank account.

8. The system of claim 7, said system further comprising a suggestion engine configured to based on prediction(s) performed by the prediction engine, suggest how the user should organize his/her/its funds flow, what seasonal variations does the user transactions have, during what time periods does the user have more receivables than payables, and during what time periods does the user have more payables than receivables, objectively indicate what user's actions should be while committing to payables so that the future receivables can be pre-claimed and used in a manner so as to reduce liabilities and interest.

9. The system of claim 1, wherein said system comprises a rating engine configured to enable any or a combination of the second set of users, said user, and said third set of users to be rated by each other and/or by said system to enable reliability determination of said rated user.

10. A method comprising:
registering, at a server, a user by receiving information pertaining to a bank account and retrieving actual available balance of said bank account;
receiving, at said server, from a second set of users, one or more future assured receivables for said bank account, each of said one or more future assured receivables indicating an assured irrevocable amount that would be credited to the bank account at a defined future receivables date;
receiving, at said server, from said user, one or more assured future payables to be processed from said bank account to a third set of users, each of said one or more future assured payables indicating an assured irrevocable amount that would be debited from said bank account at a defined future payables date; and
computing, at said server, in real-time, an assured balance for said bank account based on said actual available balance in the bank account, said one or more assured receivables, and said one or more assured payables, wherein said user is allowed to pre-claim at least a part of the one or more assured receivables before said part of said one or more assured receivables is actually credited to the bank account.

11. The method of claim 10, wherein at least a second part of the one or more future assured receivables is booked for meeting at least a part of said one or more assured future payables after said second part of the one or more future assured receivables is credited to the bank account.

12. The method of claim 10, wherein an interest is charged to said user based on the date on which said at least a part of the one or more assured receivables is pre-claimed, and the date on which said at least a part of the one or more assured receivables is actually credited.

13. The method of claim 10, wherein said user is not allowed to book an accounts payable that is greater than the assured balance, said assured balance being computed as a sum of said actual available balance in the bank account and said one or more assured receivables minus said one or more assured payables.

14. The method of claim 10, wherein at least one of the one or more future assured payables is determined automatically from a transaction note presented to the user, wherein said transaction note is any or a combination of an invoice, a quotation, and a purchase order.
